(19) United States
(12) Patent Application Publication
(10) Pub. No.: US 2026/0046981 A1
(43) Pub. Date: Feb. 12, 2026

(54) GLAZING

(71) Applicant: AGC GLASS EUROPE, Louvain-la-Neuve (BE)

(72) Inventors: Ales MARESKA, Gosselies (BE); Martin STROBL, Gosselies (BE)

(73) Assignee: AGC GLASS EUROPE, Louvain-la-Neuve (BE)

(21) Appl. No.: 19/101,456

(22) PCT Filed: Oct. 18, 2023
(86) PCT No.: PCT/EP2023/079066

§ 371 Date: Feb. 5, 2025

(30) Foreign Application Priority Data
Oct. 19, 2022 (EP) 22202409.3

(51) Int. Cl. H05B 3/06; H05B 3/86

(52) U.S. Cl. CPC H05B 3/06; H05B 3/86; H05B 2203/014

(57) ABSTRACT

A glazing includes a window pane and an electrical element engaged to the window pane. The glazing also includes a connector connected to the electrical element defining a solder junction therebetween. The connector is adapted to electrically connect the electrical element to an electric source. The glazing also includes at least one metallic strip engaged to the solder junction and arranged covering the solder junction. At least one metallic strip is arranged such that at least one end of the electrical element is sandwiched between the connector and the at least one metallic strip.

### TECHNICAL FIELD

The present disclosure relates, generally, to a glazing. More particularly, the present disclosure relates to a glazing having a window pane and an electrical element attached to the window pane.

### BACKGROUND

Automotive glass industry is offering several products requiring soldering of conductors. For example, windshield includes several electrical components that are soldered to each other to secure sufficient current transport. For example, an electrical element, such as, a heating element or an antenna mounted on a layer of the windshield are generally soldered to a connector to receive the electric current from a power source. Typically, the soldering of the electric element and the connector is performed manually via a hot soldering process during a manufacturing process of the windshield. However, a durability of such soldering joints may be week as the operator may not solder the joint properly. Accordingly, the soldered joints have tendency to break especially in the case of when the end of the electrical element is a wire-like structure, which is undesirable.

### SUMMARY

It is therefore a first aspect of the current disclosure to provide a glazing that has a strong solder joint between a connector and an electrical element provided on the glazing.

A second aspect is to provide a glazing having electrical element arranged on it, more specifically, to provide a glazing having the electrical element laminated inbetween glass sheets.

A third aspect is to provide a windshield having a strong solder joint between an electrical element, such as, a heating element or an antenna, and a connector mounted on the windshield.

At least some of the above-mentioned aspects are solved by a glazing as described in claim 1.

In some embodiments, the glazing includes a window pane and an electrical element engaged to the window pane. The glazing also includes a connector connected to the electrical element defining a solder junction therebetween. The connector is adapted to electrically connect the electrical element to an electric source. The glazing also includes at least one metallic strip engaged to the solder junction and arranged covering the solder junction. The at least one metallic strip is arranged such that at least one end of the electrical element is sandwiched between the connector and the at least one metallic strip.

In some embodiments, the connector defines at least one solder area and the at least one end of the electrical element is soldered to the at least one solder area, preferably through a lead-free solder material. In the preferred embodiment, the connector comes with solder material at the end of the connector as ready-to-solder and the soldering is done by just heating up the solder area.

The end of the electrical element is put over the solder area and then sandwiched by providing the metallic strip over the electrical element, then the solder material is heated up by the solder gun. Thus by sandwiching the end of the electrical element with the end of the connector and the metallic strip, the soldered joints are stronger and the tendency to break is avoided or at least limited.

In some embodiments, the at least one metallic strip is free of lead.

In some embodiments, the at least one metallic strip is soldered to the solder junction. The metallic strip may comprise pre-conditioned solder material to improve the strength of the junction. Thus, the solder junction with electrical element is better protected and the efficiency of the electrical element is kept. Also, no interruption in current transport occurs.

In some embodiments, the glazing is a windshield of the vehicle.

In a preferred embodiment, the connector is a flat connector as commercial Kapton® type and the metallic strip is made of a material chosen amongst copper, brass or aluminium.

In a preferred embodiment, the connector is a flat connector, the metallic strip is a busbar solder strip and the electrical element is a tungsten wire.

The electrical element, such as a wire is sandwiched between the flat connector and the metallic strip. Preferably, the assembly is soldered together to insure a strong electrical connection.

In some embodiments, the connector comprises a busbar solder strip at its end and the electrical element is a tungsten wire.

In some embodiments, the window pane is a laminated glass having a first glass layer (pane), a second glass layer (pane), and an interlayer arranged between the first glass layer and the second glass layer.

The windshield is preferably made of two window panes made of glass. The glass can thus be a glass of soda-lime-silica, aluminosilicate or borosilicate type, and the like. Preferably and for reasons of lower production costs, the glass window pane according to the invention is a sheet of soda-lime-silica glass. According to an advantageous embodiment of the invention, the composition of the glass sheet may additionally comprise one or more component(s)/colorant(s) in an appropriate amount as a function of the effect desired. This/these component(s)/colorant(s) may be used, for example, to “neutralize” the colour generated by for example the presence of the chromium and thus to render the colouring of the glass of the invention more neutral or colourless. Alternatively, this/these colorant(s) may be used to obtain a desired colour other than that which can be generated by for example the presence of the chromium.

According to another advantageous embodiment of the invention, which may be combined with the preceding embodiment, the glass window pane can be coated with a layer or a film which makes it possible to modify or neutralize the colour which may be generated by for example the presence of the chromium (for example a coloured PVB film) or to bring functionalities to the glazing.

In some embodiments, the tungsten wire as the electrical element is arranged on the interlayer. Tungsten wire may be embedded into polyvinyl butyral interlayer, commonly known as PVB, by equipment known from skilled man in the art, like drums or wire application robots.

In another embodiment, the wires of the electrical element may be made of copper.

A method for manufacturing a glazing is disclosed according to an aspect of the disclosure. The method includes soldering an electrical element to a connector defining a solder junction therebetween. The electrical element is engaged to a layer of a window pane. The method further includes engaging at least one metallic strip to the solder junction. The at least one metallic strip is arranged covering the solder junction such that the at least one end of the electrical element is sandwiched between the connector and the at least one metallic strip.

In some embodiments, the at least one metallic strip is soldered to the solder junction.

In some embodiments, the at least one metallic strip and the solder junction are pressed together upon soldering the at least one metallic strip to the solder junction.

In some embodiments, the at least one metallic strip is free from lead.

In some embodiments, the solder material used to fix the connector and/or the metallic strip is a lead-free solder material. Known solder material such as components comprising tin, copper, silver, nickel and zinc. The most common lead-free mix is tin-copper or a mix of them may be used.

In some embodiments, the glazing is a windshield of a vehicle. The windshield is preferably made of two window panes made of glass. The glass can thus be a glass of soda-lime-silica, aluminosilicate or borosilicate type, and the like. Preferably and for reasons of lower production costs, the glass window pane according to the invention is a sheet of soda-lime-silica glass. According to an advantageous embodiment of the invention, the composition of the glass sheet may additionally comprise one or more component(s)/colorant(s) in an appropriate amount as a function of the effect desired. This/these component(s)/colorant(s) may be used, for example, to “neutralize” the colour generated by for example the presence of the chromium and thus to render the colouring of the glass of the invention more neutral or colourless. Alternatively, this/these colorant(s) may be used to obtain a desired colour other than that which can be generated by for example the presence of the chromium. According to another advantageous embodiment of the invention, which may be combined with the preceding embodiment, the glass window pane can be coated with a layer or a film which makes it possible to modify or neutralize the colour which may be generated by for example the presence of the chromium (for example a coloured PVB film) or to bring functionalities to the glazing.

In some embodiments, the window pane is a laminated glass having a first glass layer, a second glass layer, and an interlayer arranged between the first glass layer and the second glass layer. The electrical element is arranged on the interlayer.

It should be emphasized that the term “comprises/comprising/comprised of” when used in this specification is taken to specify the presence of stated features, integers, steps, or components but does not preclude the presence or addition of one or more other features, integers, steps, components, or groups thereof.

### BRIEF DESCRIPTION OF THE DRAWINGS

In the following, the disclosure will be described in greater detail with reference to embodiments shown by the enclosed figures. It should be emphasized that the embodiments shown are used for example purposes only and should not be used to limit the scope of the disclosure.

FIG. 1 shows a glazing as a windshield depicting an enlarged view of an electrical element as a heating element and a connector connected to the electrical element.

FIG. 2 shows a sectional view of a lower portion of the glazing depicting various layers of the glazing.

FIG. 3 shows an enlarged view of a portion of the windshield depicting an antenna as the electric element and a connector connected to the electrical element.

FIG. 4 show an enlarged view of a lower portion of the windshield of FIG. 1 with metallic strips removed from a solder junction defined between the electric element and the connector.

### DETAILED DESCRIPTION OF THE EMBODIMENTS

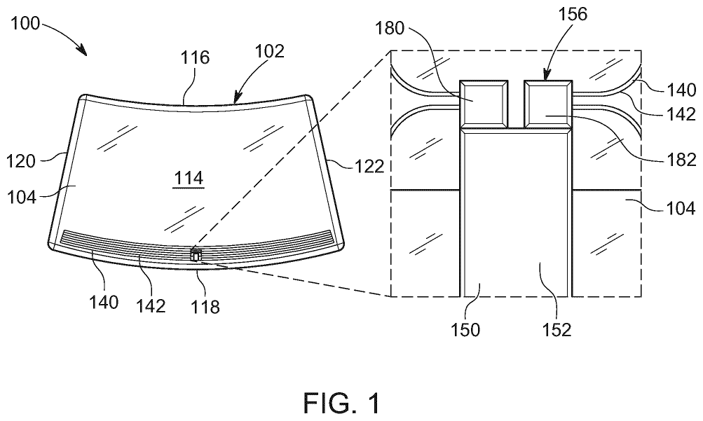

Referring to FIG. 1, a glazing 100 as a windshield 102 adapted to be attached to a body of a vehicle is shown. Although, the glazing 100 is shown and contemplated as the windshield 102, it may be appreciated that the glazing 100 may be used as a window of the vehicle, a window of a building, and like. The glazing 100 may also include backlites, side-lites, and panoramic roofs of a vehicle, a construction machine, an earthmoving machine, etc.

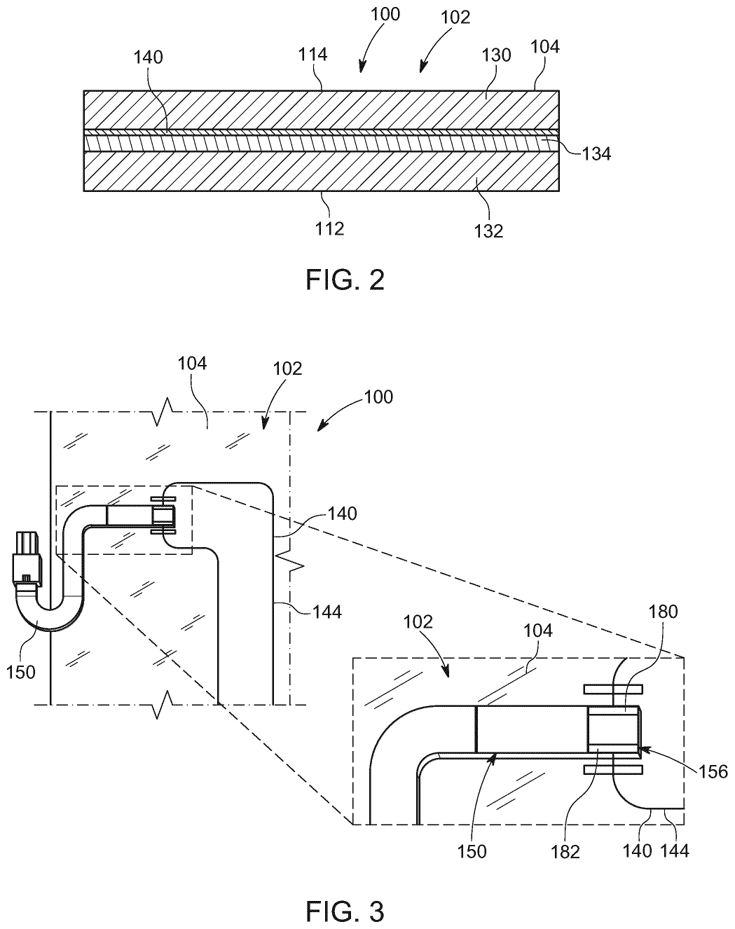

As illustrated in FIG. 1, the glazing 100 includes a window pane 104 (i.e., pane 104) having an inner surface 112 (shown in FIG. 2) arranged facing an interior of the vehicle, and an outer surface 114 disposed opposite to the inner surface and arranged facing an exterior of the vehicle. Further, the pane 104 includes an upper edge 116, a lower edge 118 disposed opposite to the upper edge 116, and a pair of side edges 120, 122 extending from the upper edge 116 to the lower edge 118 and arranged spaced apart and facing each other. In an embodiment, the upper edge 116 is attached to a roof of the vehicle, while the lower edge 118 is engaged to a lower body of the vehicle. Also, the side edges 120, 122 may be coupled with the front or rear pillars of the vehicle. In an embodiment, the pane 104 is adhesively attached to the vehicle body.

In an embodiment, as shown in FIG. 2, the pane 104 may include a laminated glass having a first glass layer 130 (i.e., an outer glass layer 130) defining the outer surface 114 of the pane 104, a second glass layer 132 (i.e., an inner glass layer 132) defining the inner surface 112 of the pane 104, and intermediate layer 134 (i.e., interlayer 134) arranged between the first glass layer 130 and the second glass layer 132 and may be made of a plastic. In an embodiment, the interlayer 134 is a poly vinyl butyral interlayer. Although, the pane 104 made of a laminated glass is shown and contemplated, it may be envisioned that the window pane 104 may be made of a toughened glass, a tempered glass, or any other suitable glass known in the art. It may be appreciated that the pane 104 is made of a transparent material and the type of transparent material, such as, glass, may depend on the application or area in which the glazing 100 is utilized.

Additionally, the windshield 102 (i.e., glazing 100) includes an electrical element 140 arranged on the pane or embedded inside the pane 104. In the embodiment, the pane 104 is a laminated glass, and the electrical element 140 is arranged on or embedded inside the interlayer 134. However, it can be envisioned that the electrical element 140 may be arranged on the outer glass layer 130 or the inner glass layer 132 as well. In the preferred embodiment, the electrical element 140 is arranged on or embedded inside the interlayer 134.

As shown in FIG. 1, the electrical element 140 is a heating element 142 in the form of an electric wire or strip that is arranged proximate to the lower edge 118 of the pane 104, and extends in a plurality of rows. Although, the heating element 142 is shown to be arranged proximate to the lower edge 118, it may be appreciated the rows of the electric wire of the heating element 142 may extend along all the edges 116, 118, 120, 122 of the pane 104. In some embodiments, the electric wire of the heating element 142 is disposed on the pane 104 in a plurality of horizontal rows arrayed from the upper edge 116 to the lower edge 118 or a plurality of vertical rows arranged between the two side edges 120, 122. In an embodiment, the heating element 142 is made of a material having a high coefficient of resistivity to enable a heating upon passage of an electric current, and hence the pane 104. In an embodiment, the electrical element 140 is a tungsten wire. In some embodiments, the electrical element 140 is a copper wire.

In some embodiments, as shown in FIG. 3, the electrical element 140 may be an antenna 144 having an electric wire to facilitate adapted to transmit and receive signals or data.

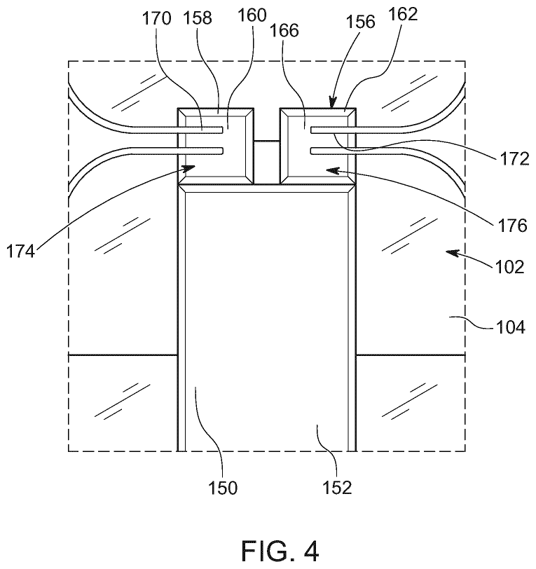

To facilitate the passage of the electric current through the electrical element 140, the glazing 100 includes a connector 150 mounted on the pane 104. The connector 150 facilitates an electrical connection of the electrical element 140 to a power source (not shown). In an embodiment, the power source may be an electric battery. As shown in FIGS. 1 and 4, the connector 150 is a busbar 152 coupled with the electrical element 140 and defining a solder junction 156 therebetween. As shown in FIG. 4, the connector 150 includes a first electric terminal 158 defining a first solder area 160 of the connector 150, and a second electric terminal 162 that defines a second solder area 166 of the connector 150 to which ends of the electrical element 140 are connected/coupled/engaged. In some embodiments, the terminals 158, 162 of the connector 150 comprise a strip of busbar ribbon to facilitate a strong and reliable connection. For example, as shown in FIG. 4, a first end 170 of the electrical element 140 is connected to the first electric terminal 158 (i.e., first solder area 160) and a second end 172 of the electrical element is connected to the second electric terminal 162 (i.e., the second solder area 166) of the connector 150. Accordingly, the first end 170 of the electrical element 140 and the first electric terminal 158 together define a first junction portion 174 of the solder junction 156, and the second end 172 of the electrical element 140 and the second electric terminal 162 of the connector 150 together define a second junction portion 176 of the solder junction 156.

Further, the glazing 100 includes at least one metallic strip, for example, a first metallic strip 180 (shown in FIG. 1 and FIG. 3) engaged to the first junction portion 174 such that the first end 170 of the electrical element 140 is sandwiched between the first electric terminal 158 and the first metallic strip 180. Similarly, the glazing 100 may include a second metallic strip 182 engaged to the second junction portion 176 such that the second end 172 of the electrical element 140 is sandwiched between the second electric terminal 162 and the second metallic strip 182. In the embodiment, the first metallic strip 180 and the second metallic strip 182 are engaged to the first solder area 160 and the second solder area 166, respectively, by soldering the metallic strips 180, 182 to the respective solder areas 160, 166. In a preferred embodiment, the metallic strips 180, 182 are strips of busbar ribbon, and in the case of both the metallic strip 180, 182 and the terminals 158, 162 of the connector 150 are strips of busbar ribbon thus the electrical element 140 is sandwiched inbetween strips of busbar ribbon. In an embodiment, each of the metallic strips 180, 182 are free from lead. By sandwiching the ends 170, 172 of the electrical element 140 between the solder areas 160, 166 and the metallic strips 180, 182, the connection between the connector 150 and the electrical element 140 is reinforced, thereby reducing or eliminating occurrences of disengagement of the electrical element 140 from the connector 150. In a preferred embodiment, the area of the metallic strip 180 or the solder junction 156 or the terminals 158, 162 of the connector 150 is much more bigger than the cross-section area of the electrical element 140, i.e., cross-section area of the wire, thus a reliable and strong connection of the electrical element 140 is provided.

A method of manufacturing the glazing 100, for example, the windshield 102, in now explained. For manufacturing the glazing 100, the electrical element 140 is engaged to the pane 104 or a layer of the pane 104. For example, the electrical element 140 is engaged to the interlayer 134 when the glazing 100 is the windshield 102 made of a laminated glass. It may be envisioned that electrical element 140 is arranged on or embedded inside the interlayer 134 by techniques or methods known in the art. Therefore, the electrical element 140 embedded onto the interlayer 134, is connected/attached to the connector 150 before the lamination step in the method of the present invention. It should be appreciated that the electrical element 140 may be arranged on the outer layer 130 or the inner layer 132 as well depending on the application area.

Upon engaging the electrical element 140 with the pane 104, the connector 150 is attached/engaged to the electrical element 140 as well as mounted on the pane 104 or layer of the pane 104. Engagement of the electrical element 140 with the pane 104 should be understood as placement of the electrical element 140 onto the pane 104, i.e., the interlayer 134 with the electrical element 140 is laid over the pane 104. Afterwards, the terminals of the connector 150 is brought close to the ends of the electrical element 140. For so doing, in an embodiment, the first end 170 of the electrical element 140 is soldered to the first electric terminal 158 defining the first junction portion 174 and the second end 172 of the electrical element 140 is soldered to the second electric terminal 162 defining the second junction portion 176. The soldering may be performed by a hot soldering process. The first junction portion 174 and the second junction portion 176 together define the solder junction 156. Subsequently, at least one metallic strip is engaged to the solder junction 156. For example, the first metallic strip 180 is engaged to the first junction portion 174 such that the first end 170 of the electrical element 140 is sandwiched between the first solder area 160 (i.e., first electric terminal 158) of the connector 150 and the first metallic strip 180. Similarly, the second metallic strip 182 is engaged to the second junction portion 176 such that the second end 172 of the electrical element 140 is sandwiched between the second solder area 166 (i.e., second electric terminal 162) and the second metallic strip 182. In an embodiment, the first metallic strip 180 is soldered to the first junction portion 174, while the second metallic strip 182 is soldered to the second solder junction 176. The soldering of the metallic strips 180, 182 to the solder junction 156 may be performed via a hot soldering process. In the case strips of busbar ribbon used for the metallic strips 180, 182, busbar ribbon is cut as strips for soldering the electrical element 140. After performing the soldering of the first metallic strip 180, the first metallic strip 180 and the first junction portion 174 is pressed together by using a pressing tool to ensure a strong bonding of the first metallic strip 180 with the first junction portion 174. Similarly, the second metallic strip 182 and the second junction portion 176 is pressed together by using a pressing tool to ensure a strong bonding of the second metallic strip 182 with the second junction portion 176.

Upon soldering the metallic strips 180, 182 to the solder junction 156, in the embodiment in which the electrical element 140 is attached to the interlayer 134, the outer layer 130 and the inner layer 132 are attached to the interlayer 134 such that interlayer 134 along with the electrical element 140 is arranged between the outer layer 130 and the inner layer 132. As the electrical element 140 is firmly secured with the connector 150 using the metallic strips 180, 182, the occurrences of disconnection of the electrical element 140 and the connector 150 is reduced during transportation or attachment of the outer layer 130 and/or the inner layer 132 with the interlayer 134.

It is to be noted that the figures and the above description have shown the example embodiments in a simple and schematic manner. Many of the specific mechanical details have not been shown since the person skilled in the art should be familiar with these details and they would just unnecessarily complicate this description. For example, the specific materials used have not been described in detail since it is maintained that the person skilled in the art would be able to find suitable materials to manufacture the glazing (i.e., windshield) according to the current disclosure.

Furthermore, the figures show additional features which the person skilled in the art will be able to understand. As such, they have not been described in detail herein.

1. A glazing, comprising:
a window pane:
an electrical element engaged to the window pane:
a connector connected to the electrical element defining a solder junction therebetween, wherein the connector is adapted to electrically connect the electrical element to an electric source; and
at least one metallic strip engaged to the solder junction and arranged covering the solder junction, wherein the at least one metallic strip is arranged such that at least one end of the electrical element is sandwiched between the connector and the at least one metallic strip.

2. The glazing according to claim 1, wherein the connector defines at least one solder area and the at least one end of the electrical element is soldered to the at least one solder area.

3. The glazing according to claim 1, wherein the at least one metallic strip is made of copper, brass or aluminium.

4. The glazing according to claim 1, wherein the at least one metallic strip is soldered to the solder junction.

5. The glazing according to claim 1, wherein the metallic strip is a strip of busbar ribbon.

6. The glazing according to claim 1, wherein the connector is a flat connector and the electrical element is a tungsten wire.

7. The glazing according to claim 1, wherein the electrical element is a heating element.

8. The glazing according to claim 1, wherein the electrical element is an antenna.

9. The glazing according to claim 1, wherein the window pane is a laminated glass having a first glass layer, a second glass layer, and an interlayer arranged between the first glass layer and the second glass layer.

10. The glazing according to claim 9, wherein the tungsten wire is arranged on the interlayer.

11. A method for manufacturing a glazing, the method comprising:
soldering an electrical element to a connector defining a solder junction therebetween, wherein the electrical element is engaged to a layer of a window pane; and
engaging at least one metallic strip to the solder junction, wherein the at least one metallic strip is arranged covering the solder junction such that the at least one end of the electrical element is sandwiched between the connector and the at least one metallic strip.

12. The method for manufacturing the glazing according to claim 11, wherein the at least one metallic strip is soldered to the solder junction.

13. The method for manufacturing the glazing according to claim 11, further comprising pressing together the at least one metallic strip and the solder junction upon soldering the at least one metallic strip to the solder junction.

14. The method for manufacturing the glazing according to claim 11, wherein the at least one metallic strip is made of copper, brass or aluminium.

15. The method for manufacturing a glazing according to claim 11, wherein the window pane is a laminated glass having a first glass layer, a second glass layer, and an interlayer arranged between the first glass layer and the second glass layer, and wherein the electrical element is arranged on the interlayer.
